(19) United States
(12) Patent Application Publication
(10) Pub. No.: US 2012/0305546 A1
(43) Pub. Date: Dec. 6, 2012

(54) INDUCTION COOKTOP PAN SENSING

(76) Inventors: Mariano Pablo FILIPPA, Louisville, KY (US); Daniel Vincent BROSNAN, Louisville, KY (US)

(21) Appl. No.: 13/154,190

(22) Filed: Jun. 6, 2011

(51) Int. Cl. H05B 6/04

(52) U.S. Cl. 219/660

(57) ABSTRACT

An induction heating system includes a heating coil operable to inductively heat a load with a magnetic field, a variable high frequency power source supplying a high frequency current to the heating coil, a detector for detecting a current through the coil and providing a current signal representative of the current, a controller for controlling the frequency of the current to the heating coil and responsive to the current signal from the detector to capture and analyze a current signature, the controller being operative to sweep a current operating frequency across an operating frequency spectrum, and to combine a sum of the current signature with a two-sample swing of the current signature, and determine a presence of a load on the heating coil and control the frequency of the current to the coil based on a signal resulting from the combined signal.

### BACKGROUND

The present disclosure generally relates to induction heating, and, more particularly to an induction heating apparatus capable of detecting a vessel and correspondingly controlling power to the induction heating coil.

Induction cook-tops heat conductive cooking utensils by magnetic induction. An induction cook-top applies radio frequency current to a heating coil to generate a strong radio frequency magnetic field on the heating coil. When a conductive vessel, such as a pan, is placed over the heating coil, the magnetic field coupling from the heating coil generates eddy currents on the vessel. This causes the vessel to heat.

An induction cook-top will generally heat any vessel of suitable conductive material of any size that is placed on the induction cook-top. Since the magnetic field is not visible, unless some secondary indicator is provided, it is not readily apparent whether the induction cook-top is powered (on) or off. Thus, it is possible for items placed, on the induction cook-top to be heated unintentionally, which could damage such items and create other problems.

There are multiple methods of vessel or pan detection on an induction cook-top. Some of these include mechanical switching, current detection, phase detection, optical sensing and harmonic distortion sensing. In pan sensing methods that utilize phase detection and amplitude measurements, a current transformer is typically used. When the system is operating at resonance, the optimal power transfer between the heating coil and the vessel will occur, however, resonance is dependent upon the load presented by the vessel. Thus it is advantageous to be able to determine the resonant frequency of the system for the particular load and operate at or near that frequency for that load. A current transformer measuring current through the coil will always provide a clean alternating triangular to sine wave of power output to the heating coil, whether the system is operating in resonance or non-resonance and there will be little to no distortion due to switching. While this is useful for pan detection, it becomes more difficult to determine resonant frequency. Also, current-transformer packages tend to have large package sizes and footprints, and can be expensive.

Accordingly, it would be desirable to provide a system that addresses at least some of the problems identified above.

### BRIEF DESCRIPTION OF THE EXEMPLARY EMBODIMENTS

As described herein, the exemplary embodiments overcome one or more of the above or other disadvantages known in the art.

One aspect of the exemplary embodiments relates to an induction heating system. The induction heating system includes a heating coil operable to inductively heat a load with a magnetic field, a variable high frequency power source for supplying a current to the heating coil selectively over a range of operating frequencies, a detector for monitoring the current supplied to the heating coil from the high frequency power source, and a controller operative to analyze a current signature associated with the detected current to determine a presence of a load on the heating coil. According to a further aspect of the exemplary embodiments the controller is further operative to determine the resonant frequency of the system with the particular load and operate the system as a function of that frequency for that load.

Another aspect of the exemplary embodiments relates to a method. In one embodiment, the method includes monitoring a sensor signal of an induction heating apparatus. The sensor signal corresponds to a current through a high frequency power source of the induction heating apparatus. A signature of the current through the high frequency power source is determined from the sensor signal. A sum of the current signature is combined with a two-sample swing of the current signauter. The combined signal provides an indicator of the presence of a vessel on the induction heating apparatus and an operating frequency required to drive the coil current in the presence of the vessel.

In a further aspect, the exemplary embodiments are directed to a computer program product stored in a memory. In one embodiment, the computer program product includes a computer readable program device for monitoring a sensor signal of an induction heating apparatus, the sensor signal corresponding to a current through a high frequency power source of the induction heating apparatus. The computer program product also includes a computer readable program device for analyzing the sensor signal to determine a signature of the current through the high frequency power source, combine a sum of the current signature with a two-sample swing of the current signature; and determine a presence of a vessel on the induction heating apparatus and an operating frequency required to drive the coil current in the presence of the vessel from the combined signal.

In yet another aspect, the exemplary embodiments are directed to an induction heating system. In one embodiment, the induction heating system includes a heating coil operable to inductively heat a load with a magnetic field, a variable frequency power source supplying a high frequency current to the heating coil, a detector comprising a shunt resistor in circuit with the heating coil for detecting a current signal characteristic of the current through the coil, and a controller for controlling the frequency of the current supplied to the heating coil, operative in a pan detection mode to operate the power source at a first predetermined frequency and to analyze the current signal at that frequency to determine a presence of a load on the heating coil based on the current signal.

In yet a further aspect, the exemplary embodiments are directed to an induction heating system. In one embodiment, the induction heating system includes a heating coil operable to inductively heat a load with a magnetic field, a variable frequency power source supplying a high frequency current to the heating coil, a detector comprising a shunt resistor in circuit with the heating coil for detecting a current signal characteristic of the current through the coil, and a controller for controlling the frequency of the current supplied to the heating coil, operative to sweep the current frequency across an operating frequency spectrum, the controller being further operative to analyze the current signal to determine the resonant frequency of the system in the presence of a load, based on the current signal.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 shows a schematic block diagram of an induction heating system according to an embodiment of the present disclosure;

FIG. 2 shows a schematic diagram of an induction heating system according to an embodiment of the present disclosure;

FIGS. 3A and 3B are exemplary graphs illustrating resonant and non-resonant signal signatures in an induction heating system according to an embodiment of the present disclosure.

FIG. 4 illustrates a three-dimensional surface graph 402 generated from a sweep of a sensor signal across the frequency spectrum.

FIG. 5A-5D illustrate graphs of a three-dimensional representation of current sum and 2-sample swing signal characteristics for various conditions derived from a current sensor.

FIG. 6A-6C illustrate graphs of a two-dimensional representation of combination the current sum and 2-sample swing signal characteristics according to an embodiment of the present disclosure.

FIG. 7 is a flowchart illustrating a process according to an embodiment of the present disclosure.

### DETAILED DESCRIPTION OF THE EXEMPLARY EMBODIMENTS OF THE DISCLOSURE

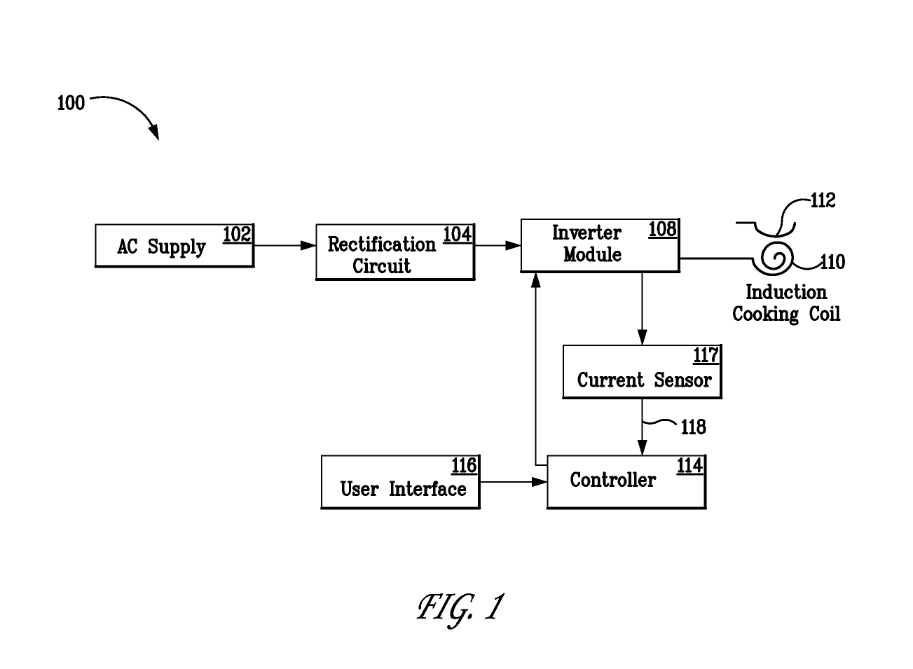

FIG. 1 is a schematic block diagram of an induction heating system 100 according to one embodiment of the present disclosure. The aspects of the disclosed embodiments are generally directed to detecting a presence of a vessel on the induction heating coil and controlling the power supplied to the induction heating coil at a power level selected by a user from a range of user selectable power settings, where the power supplied is based on size and type of vessel detected and selected power setting.

As shown schematically in FIG. 1, in one embodiment, the induction heating system 100 generally includes a source of AC power 102, which may be the conventional 60 Hz 240 volt AC supplied by utility companies, and a conventional rectifier circuit 104 for rectifying the power signal from AC power supply 102. Rectifier circuit 104 may include filter and power factor correction circuitry to filter the rectified voltage signal in a manner well known in the art. The induction heating system 100 also includes a resonant inverter module 108 for supplying high frequency current to the induction heating coil 110. The induction heating coil 110, when supplied by the resonant inverter module 108 with high frequency current, inductively heats a cooking vessel 112 or other object placed on, over or near the induction heating coil 110. It will be understood that use of the term “cooking vessel” herein is merely exemplary, and that term will generally include any object of a suitable type that is capable of being heated by an induction heating coil.

The frequency of the current supplied to the heating coil 110 by inverter module 108 and hence the output power of the heating coil 110 is controlled by controller 114 which controls the switching frequency of the inverter module 108. A user interface 116 which enables the user to establish the power output of the heating coil by selecting a power setting from a plurality of user selectable settings is operatively connected to controller 114. A current detector in the form of sensor circuit 117 senses the current supplied to the heating coil 110 by the inverter circuit 108 and provides a current signal 118 to controller 114. 110. The current sensor signal 118 is a voltage that is representative of the current flowing through the induction heating coil 110 derived from the voltage across a shunt resistor coupled to the coil power circuit. Controller 114 uses the inputs from the user interface 116 and the current sensor signal 118 from sensor circuit 117 to control energization of the heating coil 110. In one embodiment, controller 114 uses the current sensor signal 118 to sense or detect the presence of a vessel 112 on the induction heating coil 110, determine a size and type of vessel, and determine the resonant frequency of the system 100 when heating the detected vessel and determine the appropriate switching frequency to achieve the output power corresponding to the user selected power setting.

In one embodiment, a controller 114 is operative to control the frequency of the power signal generated by inverter module 108 to operate the coil 110 at the power level corresponding to the setting selected by the user via user interface 116. The controller 114 monitors the sensor signal 118 and processes the sensor signal 118 to determine, inter alia, the presence of a cooking vessel 112 on the heating coil 110 as well as a size and type of the vessel 112 and the resonant frequency of the power circuit with the vessel present. Based on the determined size and type of vessel, or lack thereof, the controller 114 is configured to control power to the induction heating coil 110, which can include turning the power off.

By analyzing the characteristics of the sensor signal 118 across a frequency spectrum, the disclosed embodiments can determine whether a cooking vessel is present on the induction heating coil 110, the size and type of the cooking vessel and the appropriate frequency required to drive the induction heating coil 110 at the user selected power setting. In one embodiment, the controller 114 is configured to sweep the sensor signal 118 across a predetermined frequency spectrum. The results of this sweep are then compared to data values in a look-up table, or other suitable data facility, in order to determine the required operating frequency to drive the induction heating coil 110 for the user selected power setting. The predetermined frequency spectrum needs to be high enough at its upper limit to be above the maximum resonant frequency of the system under all likely operating conditions for the system. The low end of the spectrum should be high enough to avoid a potentially annoying audible hum. For the exemplary cooking appliance embodiments, a range on the order of 20-50 KHz, satisfies this criterion and has been found to provide satisfactory results.

The sensor signal 118 is sampled repetitively during each full switching cycle of the power circuit at a 1 sample/microsecond sampling rate. The collection of sampled values of sensor signal 118 over a switching cycle comprises a current signature, which is captured and analyzed by the controller 114.

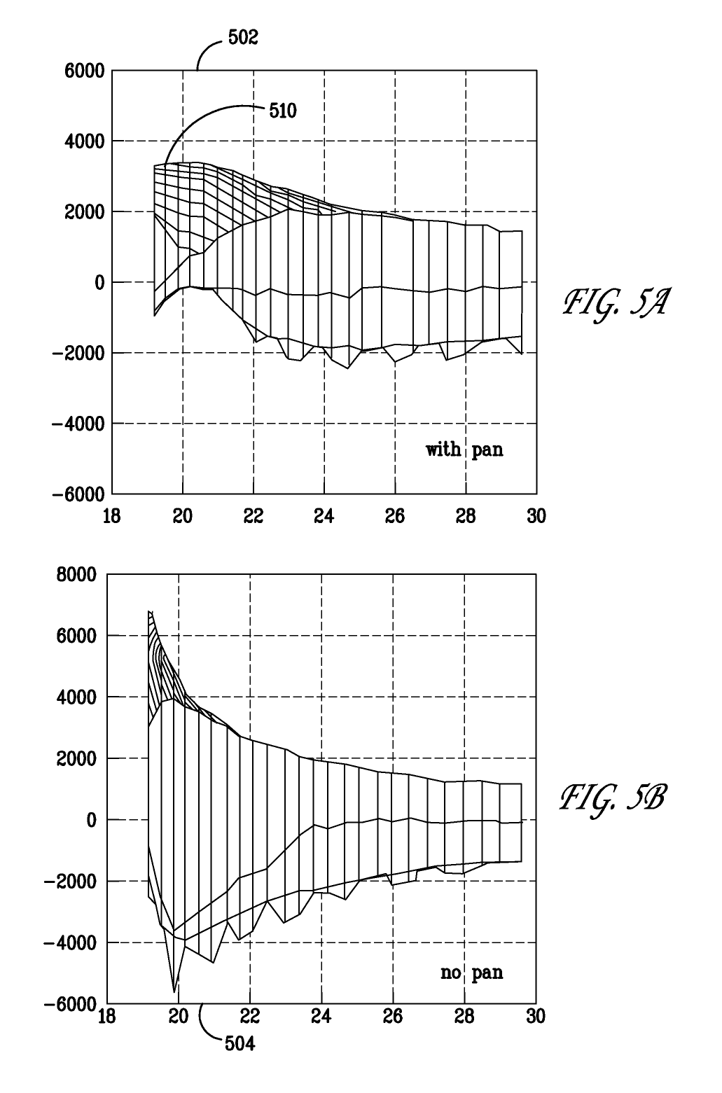

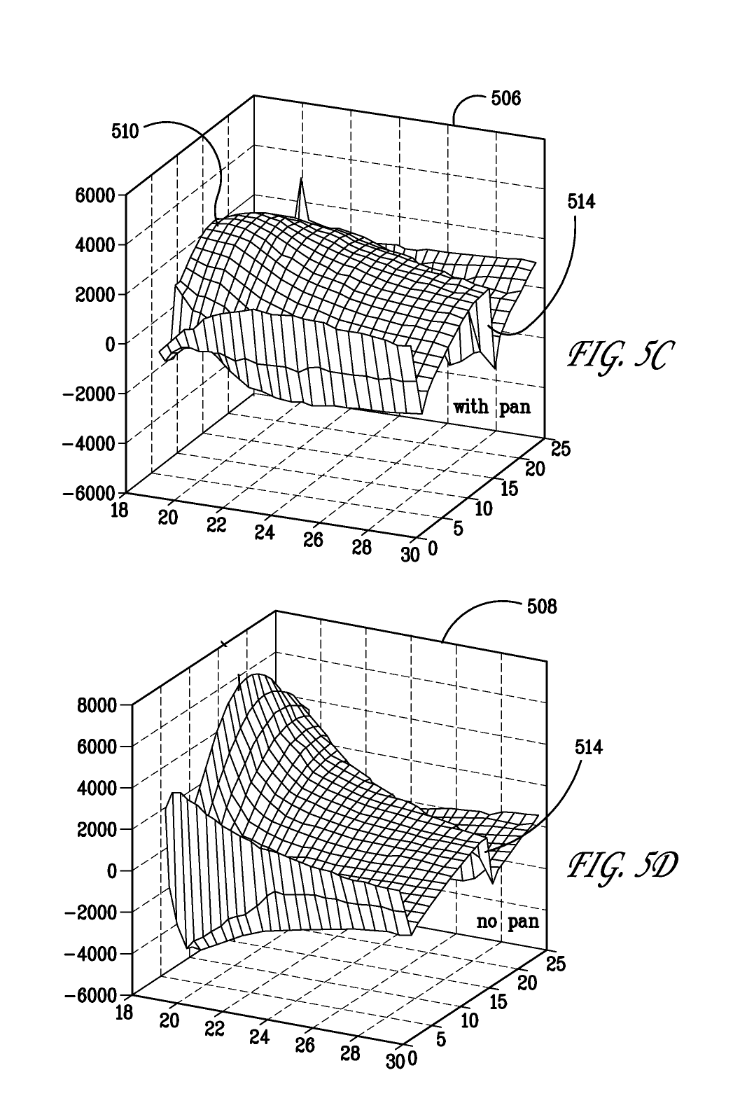

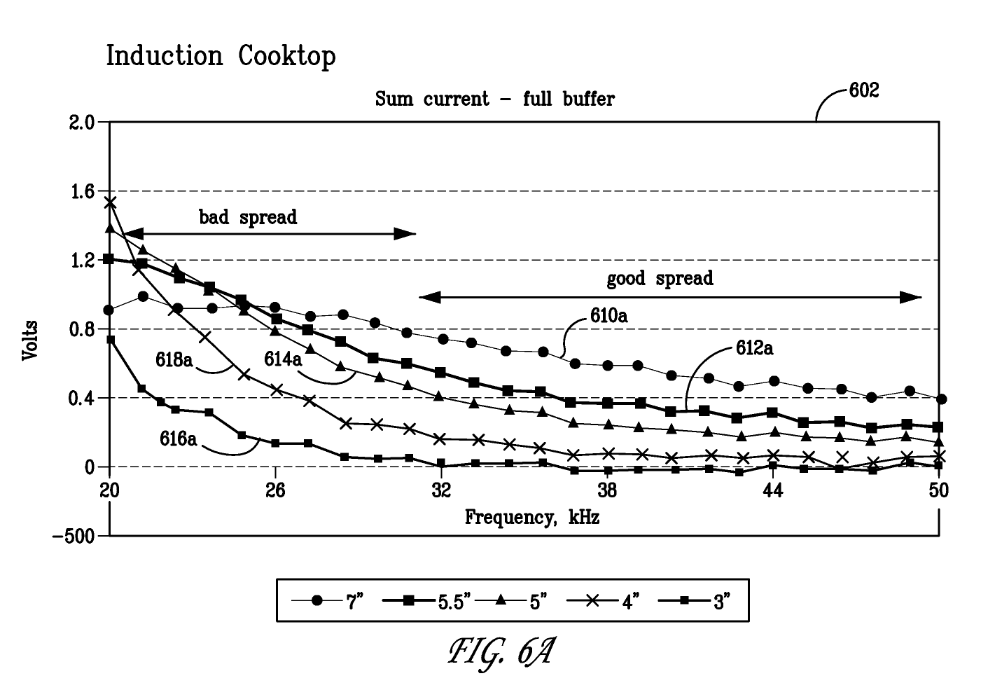

The theory of operation will be described with reference to the three dimensional surface plots illustrated in FIGS. 4 and 5a-5d. The sensor signal 118 when the switching frequency of the inverter module is swept across the operating frequency spectrum creates a three-dimensional surface plot, where the three dimensions are current, time and frequency. Referring for example to FIG. 4, time (samples) is shown on the X-axis, current feedback (signal 118) on the Y-axis, and switching frequency on the Z-axis. The plot 402 identifies the resonant frequency, as well as how the resonant frequency is detected as frequency sweeps, in one use scenario. The resonance frequency occurs at the PEAK 410 of the surface (as illustrated around Freq=20K, Time=˜10).

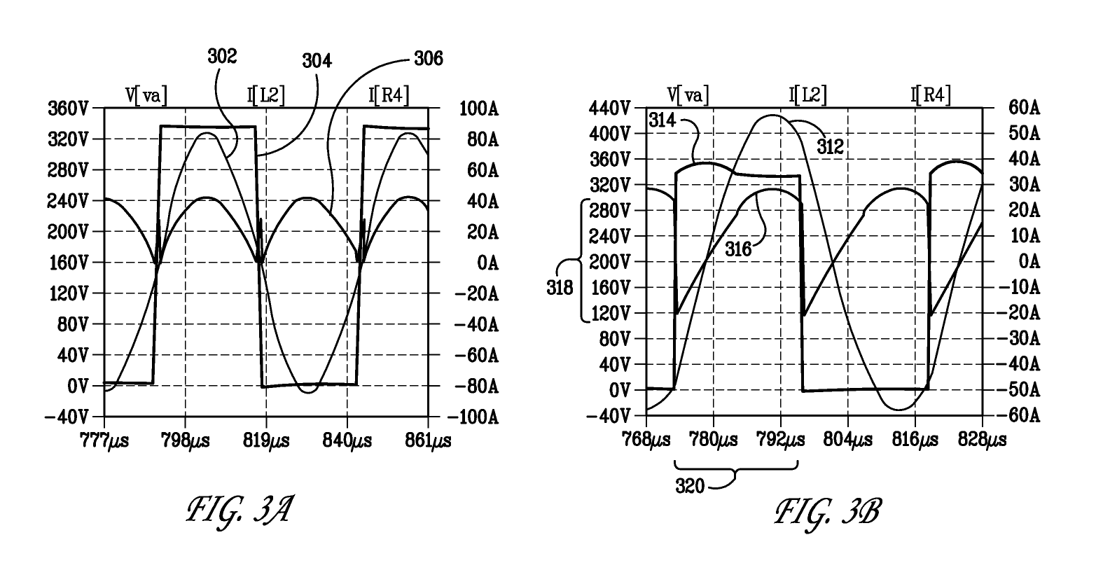

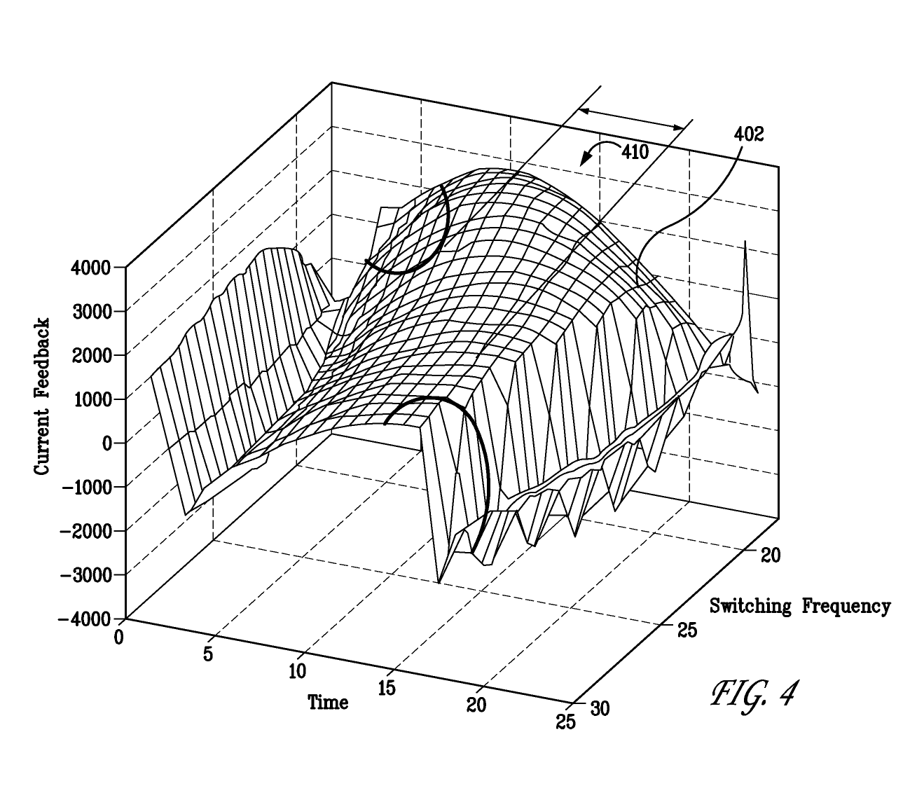

In one embodiment, two values are calculated from the sensor signal 118 represented in FIG. 3B on trace 316, to achieve accurate vessel detection. The first signal is the sum of the sampled current data points over a test cycle, which is illustrated by the integration of trace 316 over the samples of a cycle 320. The second, 2-sample swing is the delta Δ illustrated by the magnitude of the chopped portion of the sensor signal trace 318 in FIG. 3B. Three-dimensional representations of these signals in the frequency domain are shown in FIG. 5a-5d.

In FIGS. 5a and 5b, the first signal, plots 502 and 504, illustrates the sum of the current data points sampled over a test cycle as a function of the frequency of the test cycle. Plot 502 illustrates the current sum plot in the presence of a pan, at the resonant frequency, while plot 504 is the current sum without any pan. As shown in plot 502, at resonant frequency, the amount of negative current is at a minimum. Where the current peaks there is little to no negative current detected.

The current sum plots 502 and 504 are the integration of the peak-to-peak magnitude of current (Y-axis) over time at any given frequency (X-axis). In one embodiment, the system operates at resonance, which is the vertical line that runs through the peak 510 in plot 502. At this point, the current levels in the plot 502 does not cross into negative current levels because the system is in resonance and the current levels in plot 504 always cross into negative current levels because the system is not in resonance.

The second signal, the swing signal, is shown in plots 506 and 508 of FIGS. 5c and 5d, respectively. Plot 506 is in the presence of a pan, while plot 508 is without a pan. In this 2-sample swing plot, when the sensor signal “chops”, the magnitude of the sharp drop-off is the vertical component of the front face 514 of plots 506 and 508.

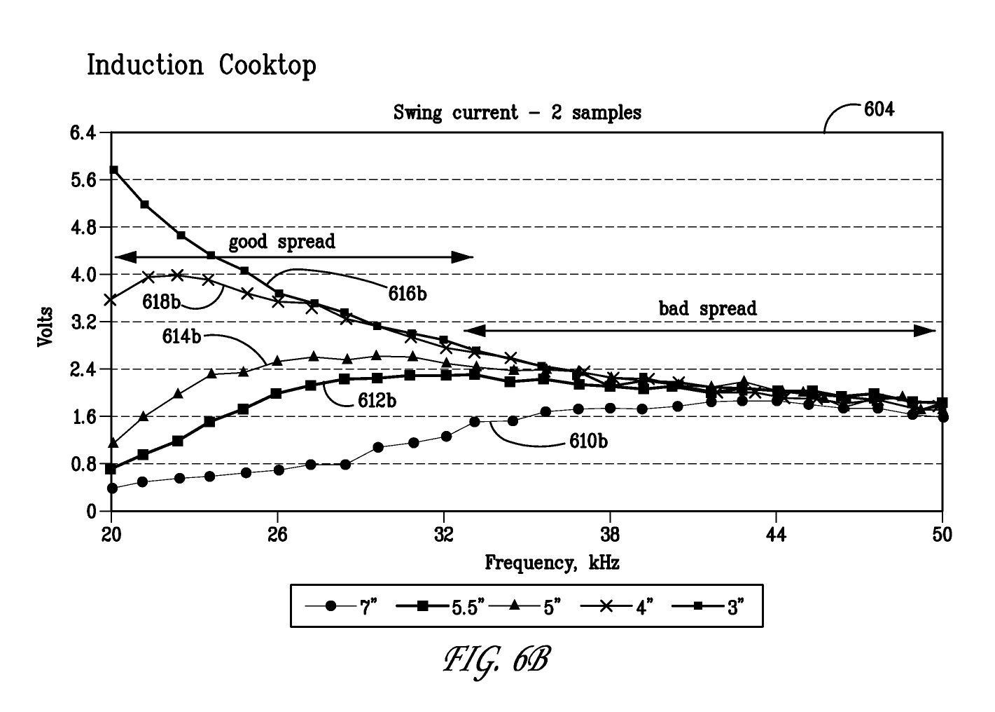

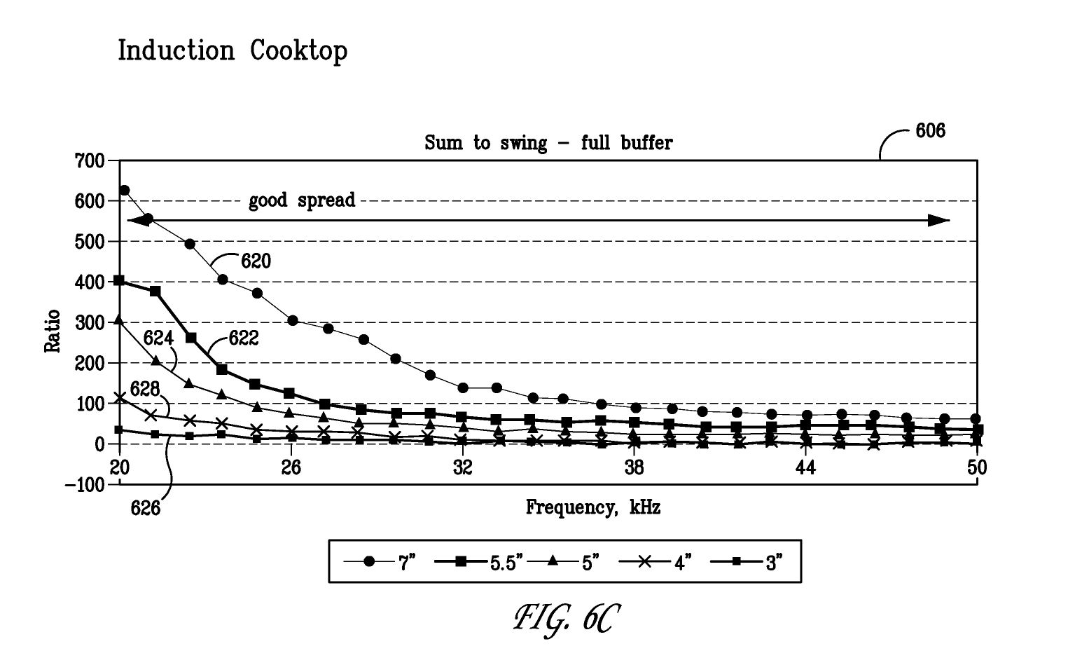

While independently the first signal and the second signal are not generally reliable as an indicator of the presence of a vessel on the induction heating coil 110 of the system in FIG. 1, when the first and second signal are combined, the resulting signal is a very accurate for vessel detection. Referring to FIGS. 6A and 6B, each of the traces 610a,b-618a,b on the plot 602 represents a different pan size, and the initial signal produced by the pan-sensing algorithm of the disclosed embodiments, responsive to the sensor signal 118 generated when the pan is detected on the induction heating coil 110. Traces 610a, 610b represent a 7 inch pan, traces 612a, 612b a 5.5 inch pan, traces 614a, 614b a 5 inch pan, traces 618a, 618b a 4 inch pan and traces 616a, 616b a 3 inch pan. In the “no pan” detected situation, there will be little to no feedback generated.

As illustrated in FIG. 6A, in the case of the current sum plot 602, the signals at the higher frequencies are reliable because they do not overlap (referred to as a “good spread”). However, at the low end, the frequencies begin to overlap, and the signal is no longer a reliable indicator of size (referred to as a “bad spread”). For the two-sample swing current plot 604 in FIG. 6B, the low end frequency signals are accurate (good spread), but the higher frequencies begin to overlap (bad spread).

However, as illustrated in FIG. 6C, by combining respective signals (610a,b; 612a,b; 614a,b; 618a, b; and 616a,b) from the current sum plot 602 and the 2-sample swing plot 604, such as by dividing two corresponding signals, a very reliable indicator for identifying the presence and size of a vessel on an induction heating coil is generated. In the illustrative embodiment, the current sum data points are divided by the 2-sample swing data points and multiplied by a gain factor to enhance the resolution. This is expressed in the equation (SUM/SWING)*GAIN. In the embodiment providing the date in FIG. 6C, the gain factor was 256. In alternate embodiments, any suitable method of combining signals may be used, other than dividing. Plot 606 illustrates the traces resulting from the combination of the respective signals in the current sum plot 602 and the 2-sample swing plot 604. Trace 620 represents the combination of trace 610a and 610b; trace 622 represents the combination of traces 612a and 612b; trace 624 represents the combination of traces 614a and 614b; trace 628 represents the combination of traces 618a, 618b; and trace 626 represents the combination of traces 616a and 616b. As shown by the plot 606 in FIG. 6C, the resulting signals 620, 622, 624, 626 and 628 accurately detect vessel size to a resolution of approximately ¼”. The resulting signals 620-628 shown in plot 606 can be used to detect a presence of a pan, detect if the pan is off center, detect a moving pan as well as infer various pan materials.

The controller 114 is constantly monitoring the sensor signal 118, calculating the current sum and swing signal plots, and determining the required operating frequency of the power supplied to the induction heating coil 110 based on values determined from a look-up table that corresponds to the current sum and swing signal plots. In the situation where a pan is moving or off center, the sensor signal 118 will be changing, which alters the sum-swing ratio. The changing sum-swing ratio results in a different resonant or optimal operating frequency in the look-up table. Generally, as a pan is being removed from the induction heating coil 110, the required operating frequency will fold back since less power is delivered to the pan. When the pan is below a certain size, or removed from the induction heating coil 110, the system 100 will cut-off; meaning no further power is delivered.

A comparison of a situation where a small pan is centered on the induction heating coil 110 and a large pan is off-center shows that the system 100 behaves in a similar fashion in each situation. The sum-to-swing ratio will generally be similar for both situations because the sensor signal 118 is a function of the resonant circuit the pans create with respect to the induction heating coil 110. This sum-to-swing ratio can be the same for multiple, different conditions, including pan size, placement and material, for example. The look-up table values are determined by experimentation under different conditions with different size, placement and materials of cooking vessels. The switching of the inverter module 108 by the switching module 116 will be based on the sum-to-swing value pointing to an operating frequency in the look-up table.

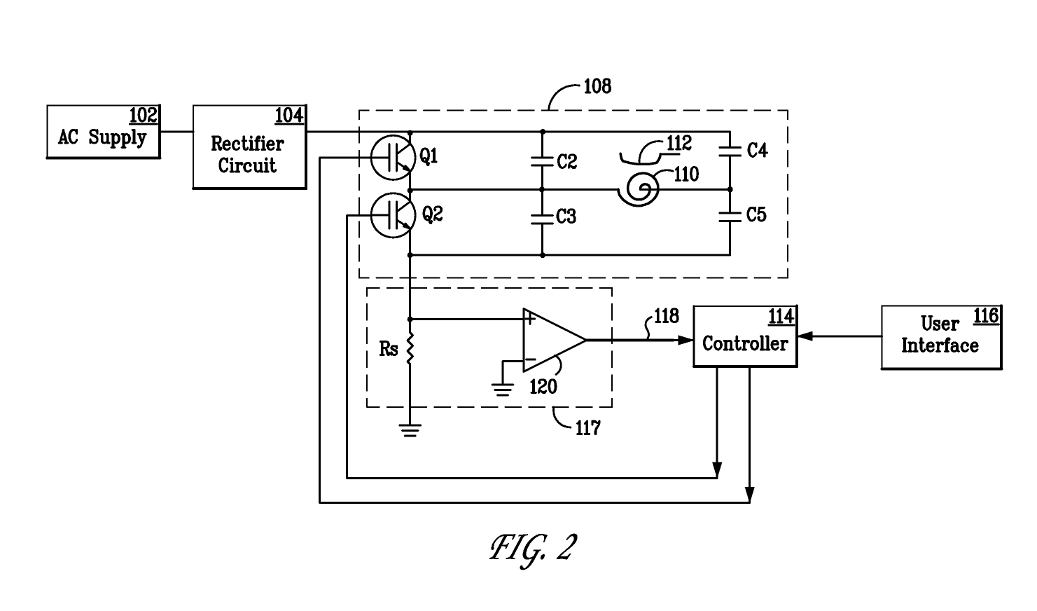

FIG. 2 is a schematic diagram of an embodiment of the system illustrated in FIG. 1. As shown in FIG. 2 the induction heating system 100 comprises an AC power supply 102, rectification circuit 104, inverter module 108, current sensor circuit 117, user interface 116 and controller 114. Inverter module 108 is a half-bridge series resonant converter circuit known in the art comprising switching devices Q1 and Q2, and capacitors C2, C3, C4 and C5, which provides high frequency power signal to the induction coil 110 by the controlled switching of the direct voltage provided from the rectification circuit 104. Controller 114 controls the switching of Q1 and Q2. In one embodiment, the switching devices Q1 and Q2 are Insulated-Gate Bipolar Transistors (“IGBT”). In alternate embodiments, any suitable switching devices can be used, other than including IGBT's. Snubber capacitors C2, C3 and resonant capacitors C4, C5 are connected between a positive power terminal and a negative power terminal to successively resonate with the induction heating coil 110.

The induction coil 110 is connected between the switching devices Q1, Q2 and induces an eddy current in a vessel 112 located on or near the induction coil 110. The eddy current heats the vessel 112.

In one embodiment, this switching of switching devices Q1 and Q2 occurs at a switching frequency in a range between approximately 20 kilohertz to 50 kilohertz. When switching device Q1 is turned on, and switching device Q2 is turned off, the resonance capacitor C5, the induction coil 110 and pan 112 form a resonant circuit. When the switching device Q1 is turned off, and switching device Q2 is turned on, the resonant capacitor C4, the induction coil 110, and the pan 112, form a resonant circuit. Current sensing circuit 117 provides a sensor signal 118 to controller 114. Sensing circuit 117 comprises shunt resistor Rs and differential amplifier 120. Resistor Rs is connected in series with the inverter circuit in the return current path. The voltage across Rs is input to the differential amplifier 120 which buffers the signal. The output from amplifier 120 provides the current sensor signal 118 which is input to controller 114. By this arrangement, sensor signal 118 is representative of the current through the induction coil 110. The controller 114 analyzes the sensor signal 118 to detect a vessel and switch or halt powering of the induction coil 110.

By examining the sensor signal 118, the induction heating system 100 can identify the presence, or lack thereof of a vessel 112 over the induction cooking coil 110. Also, operating at the resonant frequency is key to transferring the optimal amount of power from the induction coil 110 to the vessel 112 shown in FIG. 2. Analysis of signal 118 as a function of switching frequency can also be used to detect the resonant frequency of the system with a vessel in position for heating.

FIGS. 3A and 3B illustrates examples of the sensor signal 118 when the system 100 is operating at the resonant frequency, (FIG. 3A), and above the resonant frequency (FIG. 3B). Referring first to FIG. 3A, the substantially square wave curve 304 represents the switching cycle of Q1 and Q2. The curve 304 is high when Q1 is on and low when Q2 is on. The curve 306 represents the sensor signal 118 when the switching frequency equals the resonant frequency of the system. The sinusoidal curve 302 illustrates the current through the induction coil 110 or equivalently the voltage signal from a current transformer sensing the current through the induction heating coil 110.

As is seen in FIG. 3A, when the system 100 is operating at its resonant frequency, the sensor signal 118, as represented by curve 306, is smooth because the system 100 is switching at zero current. The substantially square wave curve 314 in FIG. 3B represents the switching cycle of Q1 and Q2. As shown in FIG. 3B, the sensor signal 118, as represented by curve 316, is a “chopped sinusoid” because the system 100 is switching at a non-zero current. The curve 316 sharply transitions when the system 100 operates above the resonant frequency. A comparison of the sensor signal (306 in FIGS. 3A and 316 in FIG. 3B) with the signal from a current transformer (signal 302 in FIG. A and 312 in FIG. 3B) shows the advantage of the use of sensor signal 118. The sharp transition that is present in the sensor signal 118 except at the resonant frequency provides information about the frequency response of the system that is not derivable from, the current transformer generated signal which yields a clean sinusoidal wave regardless of whether the system is operating at the resonant frequency or at an off resonant frequency.

By analyzing various characteristics of the sensor signal 118, it can be determined whether a vessel 112 is present, the type and size of the vessel, as well as the resonant frequency of the system with the vessel 112 present. In one embodiment, the current signature of the sensor signal 118 is used to detect the presence of absence of a vessel and if present, the resonant frequency of the system with vessel 112 present. Once the resonant frequency is determined, the switching frequency is then adjusted to provide the output power corresponding to the user selected power setting.

The current signature of sensor signal 118 is captured and recorded by the controller 114 by sampling the signal 118 at a sampling rate of 1 sample/microsecond which corresponds to approximately 30 sampled points per switching cycle depending on the switching frequency. The presence of a vessel causes a distortion of the sensor signal 118 except at the resonant frequency of the system with the vessel present. If no vessel is present the sensor signal 118 is essentially a triangle wave to smooth sine wave where area above and below the OA line are roughly equal. This is because with no pan present the system operates sufficiently above resonance and therefore the area below the 0 current line is much greater (theoretically equaling the area above the 0 current line as the operating frequency get farther from resonance). A pan detection algorithm is executed to analyze the data to detect the presence or absence of a vessel. In accordance with an illustrative algorithm, the controller 114 initially operates the system 100 at a switching frequency substantially higher than the likely resonant frequency of the system 100. The controller 114 computes the difference from sample to sample and compares the difference to a predetermined reference value. A difference greater than a predetermined value, signifies a sharp transition characteristic of a distorted sine wave. In the illustrative example, a reference value of 0.5 amps signifies a distorted signal indicative of the presence of a vessel 112. If the sample to sample difference greater than the reference is not detected over the course of a switching cycle the controller 114 concludes that no vessel is present and the system is de-energized. If a vessel 112 is detected, the controller 114 proceeds to determine the resonant frequency for the system under the operating conditions presented by the presence of the vessel 112. To determine the resonant frequency, the sensor signal 118 is then swept across the operating frequency spectrum, 20-50 kHz, starting at 50 kHz and sweeping downward. The sensor signal 118 is analyzed as described above. Since a pan is present, the signal will be distorted until the operating frequency closely approaches or equals the resonant frequency for the system. The controller 114 continues to repeat the sampling process until a difference less than the predetermined reference is detected. The frequency at which this difference is detected is recorded as the resonant frequency.

If the user has selected the maximum power setting, the system continues to operate at this frequency to provide the selected maximum power. If the user selected a setting less than the maximum power setting, the controller 114 will consult a look up table to determine the frequency adjustment relative to the resonant frequency needed to reduce the power to the power level corresponding to the user selected power level. The look up table comprises an empirically determined data set which provides the change in frequency relative to resonance which will provide the output power for each of the user selectable power settings.

A three-dimensional surface representation of the resulting current sensor signal 118, with each of the X, Y and Z axes representing current (amperes), time (seconds) and frequency (Hz), respectively is shown in FIG. 4, where the trace 316 of the sensor signal 118 from FIG. 3B is illustrated in the frequency domain. The surface 402 provides cues as to where the resonant frequency is, and how the surface is altered in the presence of various pans, or no pans.

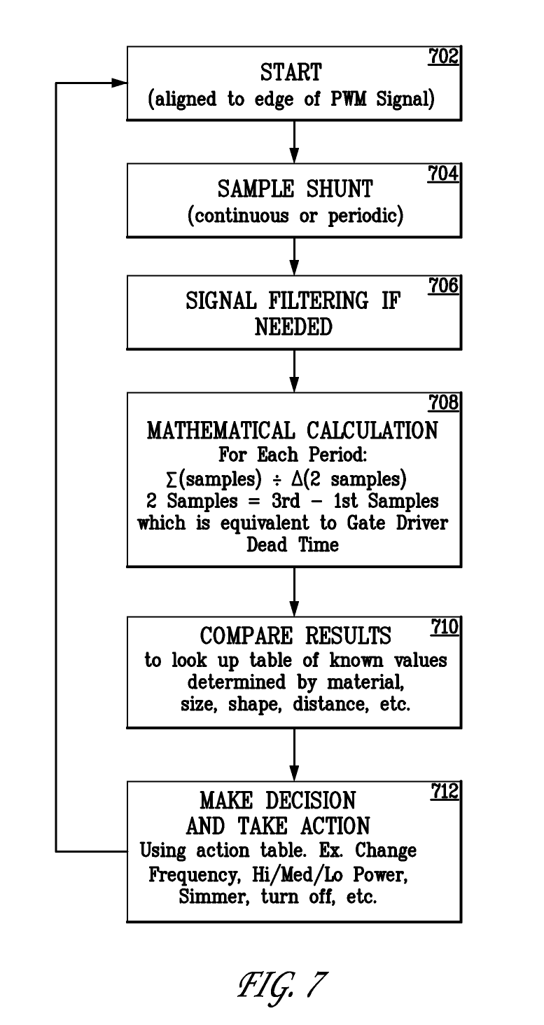

FIG. 7 illustrates an exemplary pan sensing process flow incorporating aspects of the present disclosure. In one embodiment, the sensing starts 702 when an edge of the pulse wave modulated signal indicating the switching of Q1 and Q2 is detected. The sensor signal 118, from the shunt resistor Rs is sampled 704. The frequency of the sampling can be continuous or periodic. In one embodiment, the sensor signal 118 can be filtered 706, if needed. For each sampling period, a mathematical calculation is carried out 708. The sum of the samples is divided by the delta (A) between two samples. This can be defined by the equation Σ(Samples)/Δ(2 Samples), where 2 Samples=3_{rd}−1^{st} samples, which is also equivalent to the Gate Driver Dead Time of Q1 and Q2.

In one embodiment, the results of the calculations 708 are compared 710 to known values stored in a look-up table. These known values are determined based on a number of factors corresponding to the vessel 112, including material, size, shape and distance. The look-up table can be generated using known physical properties, experimental data and assumptions. Based on the results of the comparison 710, at step 712 various actions can be taken. These can include for example, change a frequency of the switching of the resonant inverter, adjust a power level of the induction heating element 110, or turn the induction heating element 110 off.

The aspects of the disclosed embodiments may also include software and computer programs incorporating the process steps and instructions described above that are executed in one or more computers. In one embodiment, one or more computing devices, such as a computer or the controller 114 of FIG. 1, are generally adapted to utilize program storage devices embodying machine readable program source code, which is adapted to cause the computing devices to perform the method steps of the present disclosure. The program storage devices incorporating features of the present disclosure may be devised, made and used as a component of a machine utilizing optics, magnetic properties and/or electronics to perform the procedures and methods of the present disclosure. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

The computing devices may also include one or more processors or microprocessors for executing stored programs. The computing device may include a data storage device for the storage of information and data. The computer program or software incorporating the processes and method steps incorporating features of the present disclosure may be stored in one or more computers on an otherwise conventional program storage device.

The aspects of the disclosed embodiments will detect a vessel, such as a pan, on an induction heating coil, determine a size of the pan and be able to correct an operating frequency of the induction heating system accordingly to meet resonance or other appropriate operating frequency. This will aid in pan detection, energy efficiency, meet agency requirements, enable product features, suppress electromagnetic and audible noise, and protect against unsafe or damaging over voltage and under voltage conditions.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto

What is claimed is:

1. An induction heating system comprising:
a heating coil operable to inductively heat a load with a magnetic field;
a variable frequency power source supplying a high frequency current to the heating coil;
a detector for detecting a current through the coil and providing a current signal representative of said current; and
a controller for controlling the frequency of the current to the heating coil and responsive to said current signal from said detector to capture and analyze a current signature, said controller being operative to sweep the current operating frequency across an operating frequency spectrum, and to combine a sum of the current signature with a two-sample swing of the current signature, and determine a presence of a load on the heating coil and control the frequency of the current to the coil based on a signal resulting from the combined signal.

2. The system of claim 1, wherein the detector comprises a shunt resistor in series with the high frequency power source.

3. The system of claim 1, wherein the controller determines a required operating frequency based on the combined signal.

4. The system of claim 3, wherein the required operating frequency is a resonant frequency.

5. The system of claim 1, wherein the controller is further configured to determine a size of the load on the heating coil based on the combined signal.

6. A method comprising:
monitoring a sensor signal of an induction heating apparatus, the sensor signal corresponding to a current through a high frequency power source of the induction heating apparatus;
determining a signature of the current through the high frequency power source from the sensor signal; and
combining a sum of the current signature with a two-sample swing of the current signature,
wherein the combined signal provides an indicator of a presence of a vessel on the induction heating apparatus and an operating frequency required to drive the coil current in the presence of the vessel.

7. The method of claim 6, wherein the sensor signal is taken from a return path of the high frequency power source.

8. The method of claim 7, wherein a sensor used to generate the sensor signal is a shunt resistor.

9. The method of claim 7, wherein combining of the sum of a current signature with a two-sample swing of the current signature further comprises forming a ratio of the sum of the current signature and the two-sample swing of the current signature.

10. The method of claim 9, wherein a detection of the frequency is determined by comparing the ratio of the sum of the current signature and the two-sample swing of the current signature to a set of pre-determined operating conditions.

11. The method of claim 7, wherein the operating frequency is a resonant frequency.

12. The method of claim 7, further comprising determining a size of the vessel from the combined signal.

13. A computer program product stored in a memory, comprising:
a computer readable program device for monitoring a sensor signal of an induction heating apparatus, the sensor signal corresponding to a current through a high frequency power source of the induction heating apparatus;
a computer readable program device for analyzing the sensor signal to determine a signature of the current through the high frequency power source;
a computer readable program device for combining a sum of the current signature with a two-sample swing of the current signature; and
a computer readable program device for determining a presence of a vessel on the induction heating apparatus and an operating frequency required to drive the coil current in the presence of the vessel from the combined signal.

14. The computer program product of claim 13, further comprising a computer program device for forming a ratio of the sum of the current signature and the two-sample swing of the current signature from the combination of the sum of a current signature with a two-sample swing of the current signature.

15. The computer program product of claim 14, further comprising a computer program device for determining the frequency by comparing the ratio of the sum of the current signature and the two-sample swing of the current signature to a set of pre-determined operating conditions.

16. An induction heating system comprising:
a heating coil operable to inductively heat a load with a magnetic field;
a variable frequency power source supplying a high frequency current to the heating coil;
a detector comprising a shunt resistor in circuit with the heating coil for detecting a current signal characteristic of the current through the coil; and
a controller for controlling the frequency of the current supplied to the heating coil, operative in a pan detection mode to operate the power source at a first predetermined frequency and to analyze the current signal at that frequency to determine a presence of a load on the heating coil based on the current signal.

17. The induction heating system of claim 16 wherein said controller is further operative upon detecting the presence of a load to sweep the frequency of the power supply over a predetermined range and analyze the current signal to determine the resonant frequency of the system in the presence of the load, based on the current signal.

18. The induction heating system of claim 16 wherein said controller is further operative upon detecting the presence of a load to sweep the frequency of the power supply over a predetermined range and analyze the current signal to determine a characteristic of the load, based on the current signal.

19. The induction heating system of claim 18 wherein the load is a cooking pan and the characteristic of the load is the approximate diameter of the pan.

20. The induction heating system of claim 17 wherein said frequency spectrum comprises the range of 20 khz to 50 khz.

21. The induction heating system of claim 16 wherein said controller is further operative upon detecting the absence of a load to turn off the heating system.

22. An induction heating system comprising:
a heating coil operable to inductively heat a load with a magnetic field;
a variable frequency power source supplying a high frequency current to the heating coil;
a detector comprising a shunt resistor in circuit with the heating coil for detecting a current signal characteristic of the current through the coil; and
a controller for controlling the frequency of the current supplied to the heating coil, operative to sweep the current frequency across an operating frequency spectrum, the controller being further operative to analyze the current signal to determine the resonant frequency of the system in the presence of a load, based on the current signal.

23. The induction heating system of claim 22 further comprising user interface for enabling the user so select a power setting for the heating system from a plurality of selectable settings and wherein said controller is responsive to said user interface and operative after determining the resonant frequency to adjust the frequency of the current relative to the resonant frequency to operate the coil at a power level corresponding to the power setting selected by the user.

24. The induction heating system of claim 22 wherein said controller adjusts the frequency of the current to the resonant frequency to implement the highest user selectable power setting.

25. The induction heating system of claim 23 wherein for at least each of the user selectable power settings less than the highest user selectable setting, said controller adjusts the frequency of the current to a frequency greater than the resonant frequency by a difference associated with each power setting.

26. The induction heating system of claim 23 wherein the controller includes a power setting look-up table comprising the operating frequency for each of the user selectable power settings as a function of the resonant frequency and wherein the controller after determining the resonant frequency is operative to adjust the frequency of the current to the frequency determined in accordance with the look-up table for the power setting selected by the user.
